(19) United States
(12) Patent Application Publication
(10) Pub. No.: US 2007/0008889 A1
(43) Pub. Date: Jan. 11, 2007

(54) Wireless distribution system (WDS) repeater in wireless local area network (WLAN) and its control method

(76) Inventor: Cheong-Jeong Seo, Suwon-si (KR)

Correspondence Address: Robert E. Bushnell, Suite 300, 1522 K Street, N.W., Washington, DC, 20005, US

(21) Appl. No.: 11/451,478

(22) Filed: Jun. 13, 2006

(30) Foreign Application Priority Data
Jul. 11, 2005 (KR) 10-2005-0062438

(51) Int. Cl. H04L 12/26; H04J 1/16

(52) U.S. Cl. 370/232; 370/252

(57) ABSTRACT

A Wireless Distribution System (WDS) repeater in a Wireless Local Area Network (WLAN), the WDS repeater includes: a controller adapted to compare a wireless link rate of a WLAN signal received from an Access Point (AP) of the WLAN to a wireless link rate threshold registered in a wireless link rate table, and to display a connectability status of the wireless link according to the comparison result. A method of displaying a WDS link status in a wireless LAN system includes: detecting a wireless link rate of a WLAN signal received from an AP; comparing the detected wireless link rate to a wireless link rate threshold registered in a wireless link rate table; and displaying an ability to establish a connection when the detected wireless link rate is equal to or greater than the wireless link rate threshold.

### CLAIM OF PRIORITY

This application makes reference to, incorporates the same herein, and claims all benefits accruing under 35 U.S.C. § 119 from an application for WIRELESS DISTRIBUTION SYSTEM REPEATER IN WIRELESS LAN SYSTEM AND METHOD OF CONTROLLING THE SAME filed in the Korean Intellectual Property Office on 11 Jul. 2005 and there duly assigned Serial No. 10-2005-0062438.

### BACKGROUND OF THE INVENTION

1. Field of the Invention

The present invention relates to a Wireless Distribution System (WDS) repeater in a Wireless Local Area Network (LAN) and its control method.

2. Description of the Related Art

Information terminals such as a Personal Computer (PC), a laptop computer, and a Personal Digital Assistant (PDA) use a network called a Local Area Network (LAN) to share information with each other. LANs are classified into a wire LAN which connects information terminals through a communication cable and a Wireless LAN (WLAN) of a wireless communication method which employs Access Points (APs).

Of these, the WLAN performs wireless communication using a radio frequency or light for data transmission, and thus is convenient to move, extend, and maintain. The WLAN provides a 10/100 base-T Ethernet interface function of IEEE 802.3 as a wire processing unit and provides a transmission rate of 2 Mbps in a frequency band of 2.4 GHz of IEEE 802.11 as a wireless processing unit.

Since October, 1990, an IEEE 802.11 committee has been working on internationally standardizing the WLAN according to an Open System Interconnection (OSI) reference model for wireless Medium Access Control (MAC) and physical layer specifications. IEEE 802.11 follows “Standard for Information Technology-Telecommunications and Information Exchange between Systems-Local and Metropolitan Area Networks-Specific Requirements-Part ?: Wireless LAN Medium Access Control (MAC) and Physical Layer (PHY) Specifications”, 1999 edition, as a WLAN standard which is now in widespread use.

While standardization of the WLAN is still progressing, there is a trend of several physical layer specifications sharing one MAC protocol. As basic transmission technology, InfraRed (IR) communication and Radio Frequency (RF) communication are under discussion. The RF communication method employs a spread spectrum method which spreads data over a wide frequency band to perform data transmission with no interference.

The typical WLAN comprises a WLAN terminal used as an information terminal used by a user, an Access Point (AP) which is arranged between the WLAN terminal and a hub and transmits a communication network request from the WLAN terminal to an authentication server to repeat WLAN communication of a corresponding WLAN terminal, a router and a hub which access the communication network, and an authentication server which provides a communication access service. The typical WLAN further comprises a repeater which performs the same function as the AP to enhance the capability of the WLAN. The repeater uses a Wireless Distribution System (WDS) function which makes up a wireless network between the APs. If an AP that is not connected to the communication network is connected to an AP that is connected to the communication network through the WDS function, WLAN terminals can use the communication network by accessing the non-connected AP. That is, the WDS function serves as a bridge/repeater that extends an available wireless communication range.

The WLAN system based on IEEE 802.11 MAC and IEEE 802.11 a/b/g PHY is widely used in homes and offices, as many users have purchased and installed an AP or a repeater.

However, since a manual for the AP or repeater does not describe installation, the user first installs the AP or repeater in a desired region, and if it does not work, moves it closer to a main AP and installs it again. Thus, installation of the AP or repeater is difficult.

In addition, even when the AP or repeater is moved closer to the main AP, the user has no way of knowing whether or not it is within working range.

Furthermore, since the conventional WLAN system is provided to users at a low cost, most users do not have a high-priced radiolocator. Thus, the WLAN system can only be accurately installed by an installation technician having a radiolocator (e.g., yellow jacket).

### SUMMARY OF THE INVENTION

It is, therefore an object of the present invention to provide a WDS repeater in a WLAN which indicates setting information, such as an optimum setting distance between a main AP and a repeater and a transmission rate, for a user's reference when connecting the AP and the repeater to install the-WLAN, and its control method.

According to one aspect of the present invention, a Wireless Distribution System (WDS) repeater in a Wireless Local Area Network (WLAN) is provided, the WDS repeater including: a controller adapted to compare a wireless link rate of a WLAN signal received from an Access Point (AP) of the WLAN to a wireless link rate threshold registered in a wireless link rate table, and to display a connectability status of the wireless link according to the comparison result.

The controller preferably includes: a detector adapted to detect the wireless link rate of the WLAN signal received from the AP; a comparator adapted to compare the wireless link rate detected by the detector to the wireless link rate threshold registered in the wireless link table; and a display adapted to display the connectability status according to the comparison result. The controller preferably further includes: a setter adapted to change or set the wireless link rate threshold registered in the wireless link table according a data transmission rate of the WLAN signal. The controller is preferably adapted to detect the wireless link rate using one of a Communication Quality (CQ) level, a Received Signal Strength Indicator (RSSI) level, or a ping delay.

The wireless link rate table preferably includes transmission rates of the WLAN signal and at least one wireless link rate threshold depending on the transmission rate of the WLAN signal according to a draft WLAN standard.

The display preferably includes at least one LED or alarm adapted to indicate the connectability status of a wireless link to another AP.

According to another aspect of the present invention, a method of displaying a Wireless Distribution System (WDS) link status in a Wireless Local Area Network (WLAN) is provided, the method including: detecting a wireless link rate of a WLAN signal received from an Access Point (AP); comparing the detected wireless link rate to a wireless link rate threshold registered in a wireless link rate table; and displaying an ability to establish a connection when the detected wireless link rate is equal to or greater than the wireless link rate threshold.

The method preferably further includes displaying an inability to establish a connection when the detected wireless link rate is smaller than the threshold of the previously set wireless link rate.

The method preferably further includes changing or setting the wireless link rate threshold registered in the wireless link rate table according to a data transmission rate of the WLAN signal.

The wireless link rate is preferably detected using one of a Communication Quality (CQ) level, a Received Signal Strength Indicator (RSSI) level, or a ping delay.

In comparing the detected wireless link rate to a wireless link rate threshold registered in a wireless link rate table, the wireless link rate table preferably includes transmission rates of the WLAN signal and at least one wireless link rate threshold depending on a transmission rate of the WLAN signal according to a draft WLAN standard.

According to still another aspect of the present invention, a Wireless Local Area Network (WLAN) is provided including: a repeater adapted to compare a wireless link rate of a WLAN signal received from an Access Point (AP) to a wireless link rate threshold registered in a wireless link rate table and to display a connectability status of the wireless link according to the comparison result.

The repeater preferably includes: a detector adapted to detect the wireless link rate of the WLAN signal received from the AP; a comparator adapted to compare the wireless link rate detected by the detector to the wireless link rate threshold registered in the wireless link table; and a display adapted to display the connectability status according to the comparison result. The repeater preferably further includes: a setter adapted to change or set the wireless link rate threshold registered in the wireless link table according a data transmission rate of the WLAN signal. The repeater is preferably adapted to detect the wireless link rate using one of a Communication Quality (CQ) level, a Received Signal Strength Indicator (RS SI) level, or a ping delay.

The wireless link rate table preferably includes transmission rates of the WLAN signal and at least one wireless link rate threshold depending on the transmission rate of the WLAN signal according to a draft WLAN standard.

The display preferably includes at least one LED or alarm adapted to indicate the connectability status of a wireless link to another AP.

According to yet another aspect of the present invention, a Wireless Local Area Network (WLAN) is provided including: an Access Point (AP) adapted to receive a WLAN signal from a repeater; to compare a wireless link rate of the received WLAN signal from a repeater to a wireless link rate threshold registered in a wireless link rate table; and to display a connectability status of the wireless link according to the comparison result.

The AP preferably includes: a detector adapted to detect the wireless link rate of the received WLAN signal from the repeater; a comparator adapted to compare the wireless link rate detected by the detector to the wireless link rate threshold registered in the wireless link table; and a display adapted to display the connectability status according to the comparison result. The AP preferably further includes: a setter adapted to change or set the wireless link rate threshold registered in the wireless link table according a data transmission rate of the WLAN signal. The AP is preferably adapted to detect the wireless link rate using one of a Communication Quality (CQ) level, a Received Signal Strength Indicator (RSSI) level, or a ping delay.

The wireless link rate table preferably includes transmission rates of the WLAN signal and at least one wireless link rate threshold depending on the transmission rate of the WLAN signal according to a draft WLAN standard.

The display preferably includes at least one LED or alarm adapted to indicate a connectability status of a wireless link to another AP.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a schematic diagram of a WLAN system according to the present invention;

FIG. 2 is a block diagram of a repeater of the WLAN system according to an exemplary embodiment of the present invention;

FIG. 3 is a block diagram of an Access Point (AP) in the WLAN system according to another exemplary embodiment of the present invention; and

FIG. 4 is a flowchart illustrating a method of displaying a WDS link status in the WLAN system according to the present invention.

### DETAILED DESCRIPTION OF THE INVENTION

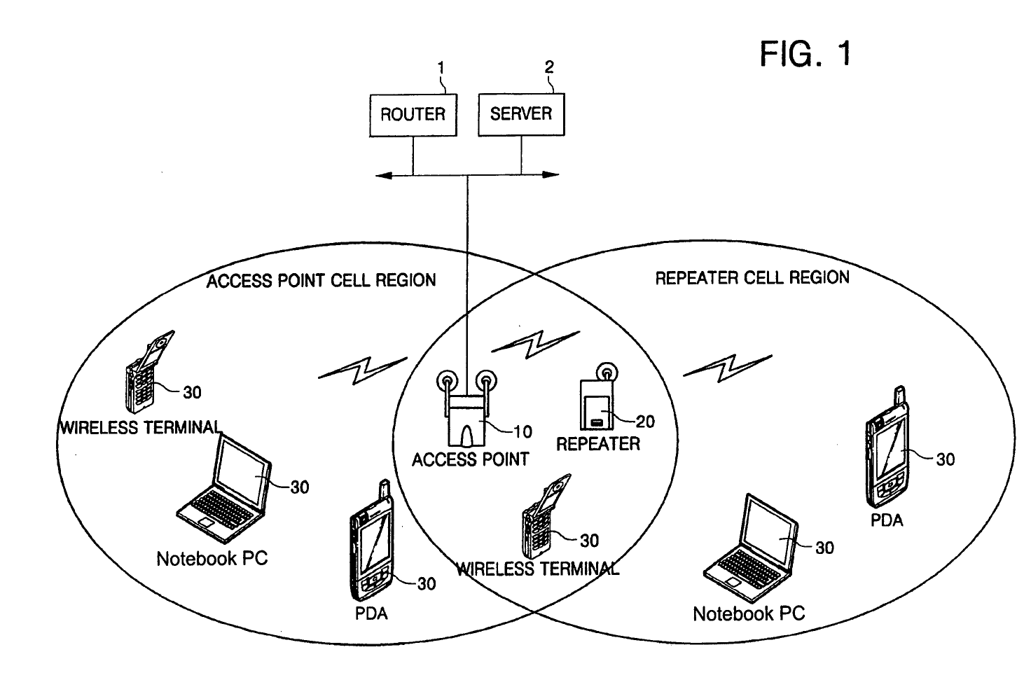

FIG. 1 is a schematic diagram of a WLAN system according to the present invention. The WLAN system of FIG. 1 comprises an AP 10, a repeater 20, and a WLAN terminal 30. With regard to the repeater 20, since the AP 10 has a repeater function, an AP 10 that functions to relay a WLAN signal is referred to as a repeater.

The AP 10 compares a wireless link rate of a received WLAN signal from the repeater 20 or the WLAN terminal 30 to a wireless link rate threshold registered in a link rate table and indicates a connectability status of a corresponding wireless link according to the comparison result. The wireless link rate of the WLAN signal is detected by using a Communication Quality (CQ) level, a Received Signal Strength Indicator (RSSI) level, or a ping delay. The CQ level is usually used as an index for performing a handoff in a mobile communication system, and the AP 10 can easily obtain the CQ information through, for example, a task for receiving the WLAN signal.

The connectability status of the link is indicated to a user through the following processed task:

```
  /*Example Function */
  void detect_link_status( )
  { .... /* conditions of 802.11b and 802.11g are first clicked here
to carry out conditions of a corresponding access environment */
  if(cq_rate >= 80) { /* LED stays turned on*/ }
  .....
  else if(cq < 30) { /* LED is flickers at an interval of one second
or various alarms are indicated*/ }
  }
```

The repeater 20 compares a wireless link rate of a WLAN signal received from the AP 10 to a wireless link rate threshold registered in a link rate table and indicates a connectability status of a corresponding wireless link according to the comparison result.

General functions and operation details of each of the components of FIG. 1 have not been described in detail here. Only the specific operation the components in the present invention have been described.

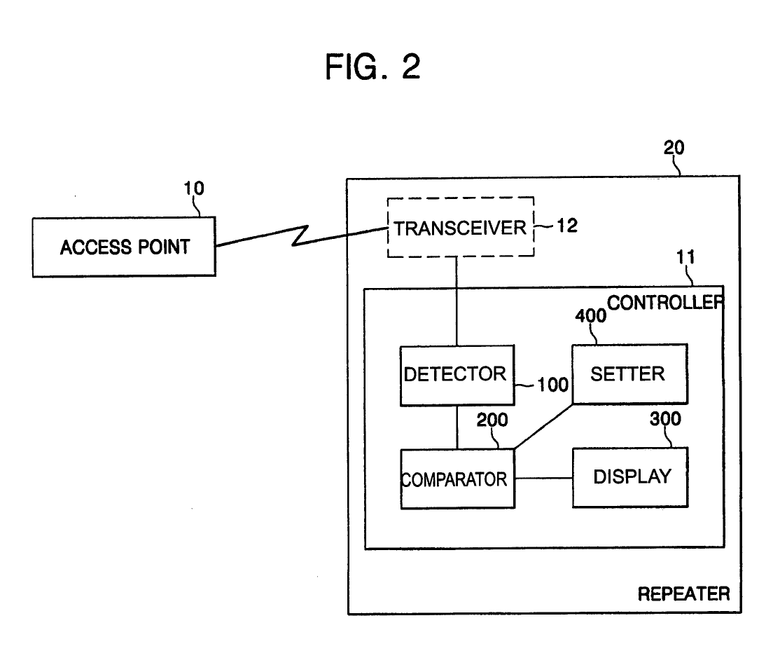

FIG. 2 is a block diagram of the repeater of the WLAN system according to an exemplary embodiment of the present invention.

The repeater 20 comprises a controller 11, which has a detector 100, a comparator 200, a display 300, and a setter 400, and a transceiver 12. The transceiver 12 functions to transmit/receive the WLAN signal to/from another AP 10 or the WLAN terminal 30.

The detector 100 detects the wireless link rate of the WLAN signal received from the AP 10 or the WLAN terminal 30. The wireless link rate of the WLAN signal detected by the detector 100 is detected by using the CQ level, the RSSI level, or the ping delay. The CQ level is usually used as an index for performing a handoff in a mobile communication system.

The comparator 200 compares the wireless link rate detected by the detector 100 to the wireless link rate threshold registered in a link rate table such as Table 1:

TABLE 1

| WDS link rate | | 802.11b | 802.11g | Remarks |
|---|---|---|---|---|
| ≧54 | Mbps | No relevant data | ≧80 | Data are averages of |
| ≧27 | Mbps | No relevant data | ≧60 | values obtained by |
| ≧11 | Mbps | ≧80 | ≧50 | self-testing |
| ≧5.5 | Mbps | ≧60 | ≧40 | |
| ≧2 | Mbps | ≧30 | ≧30 | |

Table 1 shows wireless link rates of the draft standards 802.11b and 802.11g, and a standard value of the wireless link rate is obtained by converting the CQ level into 100.

The display 300 indicates the connectability status of the corresponding wireless link to the user according to the comparison result of the comparator 200. The display 300 can inform the user of the connectability status visually or aurally by using an LED or alarm, and indicates the changing transmission rate which changes according to position.

The setter 400 changes a wireless link rate threshold previously set in the comparator 200. That is, the wireless link rate threshold is set so that the AP 100 and the repeater 20 can access each other at the user's desired transmission rate. For example, if the user desires to set a transmission rate of at least 27 Mbps between the AP 10 and the repeater 20, it can be performed by changing the wireless link rate threshold to at least 60% through the setter 400. The transmission rate cannot be set to at least 27 Mbps in the draft standard 802.11b, and the transmission rate can be set to at least 54 Mbps, 27 Mbps, 11 Mbps, 5.5 Mbps, and 2 Mbps according to the wireless link rate threshold in the draft standard 802.11 g.

A procedure for the user to install the repeater 20 according to the draft standard 802.11b in the AP 10 in the WLAN system having the above-described configuration is explained below.

First, the user operates the fixed AP 10 which is connected to the router 1 or the server 2, so that the AP 10 has a Basic Service Set (BSS) region which the repeater 20 or the WLAN terminal 30 can access.

Then, the user operates the repeater 20 which is to access the AP 10.

The detector 100 of the repeater 20 detects the wireless link rate of the WLAN signal received through the AP 10. The detector 100 detects the wireless link rate of the WLAN signal by using the CQ level, the RSSI level, or the ping delay.

Next, the comparator 200 of the repeater 20 compares the wireless link rate (e.g., 20%) detected through the detector 100 to the previously set wireless link rate (e.g., 30%). If the repeater 20 is not located within the BSS region of the AP 10 or is far from the AP 10, the detected wireless link rate (20%) is lower than the previously set wireless link rate (30%), so that the display 300 informs the user of the inability to establish a connection. The display 300 can employ an LED or an alarm.

After the above operation, the detector 100 continually detects the wireless link rate of the WLAN signal received through the AP 100, and the comparator 200 and the display 300 repetitively perform the above-described operation.

Thereafter, while the user is moving the repeater 20 toward the AP 10, the display 300 indicates the ability to establish a connection when the wireless link rate detected by the detector 100 is greater than the wireless link rate threshold registered in the wireless link rate table. For example, the LED device stays turned on, and a flicker interval of the LED changes in proportion to the transmission rate (e.g., 1 second for 54 Mbps, 2 seconds for 27 Mbps, 3 seconds for 11 Mbps, 4 seconds for 5.5 Mbps, and 5 seconds for 2 Mbps), so that the user can be aware of the transmission rate of the current position through the flickering interval.

As a result, the user connects the repeater 20 to the AP 10 at a position where the display 300 indicates that it's possible to establish a connection.

Accordingly, the user can be instantly aware of the connectability status of the wireless link through operation of the display 300 of the repeater 20 as the repeater 20 is moved.

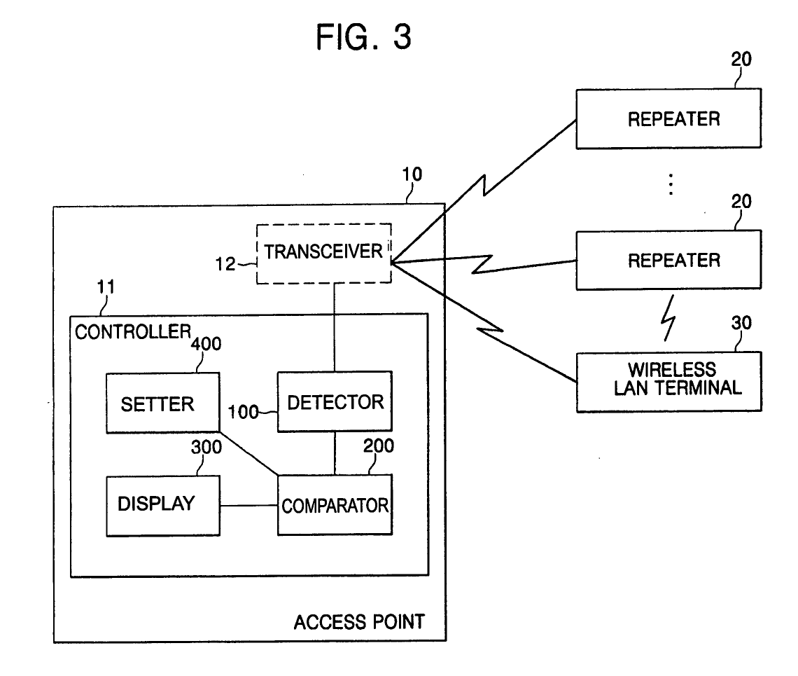

FIG. 3 is a block diagram of the AP 10 in the WLAN system according to another exemplary embodiment of the present invention.

The AP 10 comprises a controller 11, which has a detector 100, a comparator 200, a display 300, and a setter 400, and a transceiver 12. The transceiver 12 functions to transmit/receive the WLAN signal to/from another the repeater 20 or the WLAN terminal 30.

The detector 100 detects the wireless link rate of the WLAN signal received from the repeater 20 or the WLAN terminal 30.

The comparator 200 compares the wireless link rate detected by the detector 100 to the threshold of the previously set wireless link rate.

The display 300 indicates the connectability status of the corresponding wireless link according to the comparison result of the comparator 200 using an LED or alarm.

A procedure for a user to install the AP 10 and the repeater 20 in the WLAN system having the above-described configuration is explained below.

First, the user operates the fixed AP 10 which is connected to the router 1 or the server 2, so that the AP 10 has a BSS region which the AP 10 or the WLAN terminal 30 can access.

Then, another user operates the repeater 20 or the WLAN terminal 30 which is to access the AP 10 at a certain position.

The detector 100 of the AP 10 detects the wireless link rate of the WLAN signal received through the repeater 20 or the WLAN terminal 30. The detector 100 detects the wireless link rate of the WLAN signal by using the CQ level, the RSSI level, or the ping delay.

Next, the comparator 200 of the repeater 20 compares the wireless link rate detected through the detector 100 to the previously set wireless link rate. If the repeater 20 or the WLAN terminal 30 is not located within the BSS region, the detected wireless link rate is lower than the previously set wireless link rate, so that the display 300 indicates to the user the inability to establish a connection.

After the above operation, the detector 100 continually detects the wireless link rate of the WLAN signal received through the repeater 20 or the WLAN terminal 30, and the comparator 200 and the display 300 perform the above-described operations.

Thereafter, while the other user is moving the repeater 20 toward the AP 10, the display 300 indicates the ability to establish a connection when the wireless link rate detected by the detector 100 is greater than the threshold (e.g., 30%) of the wireless link rate registered in the wireless link rate table. For example, the LED device stays turned on, and a flicker interval of the LED varies according to the transmission rate (e.g., 1 second for 54 Mbps, 2 seconds for 27 Mbps, 3 seconds for 11 Mbps, 4 seconds for 5.5 Mbps, and 5 seconds for 2 Mbps), so that the user can be aware of the transmission rate at the current position through the flickering interval.

As a result, the user connects the repeater 20 to the AP 10 at the position where the display 300 indicates that a connection can be established.

Accordingly, the user can instantly be aware of the connectability status of the wireless link through operation of the display 300 of the AP 10 while the other user moves the repeater 20.

Since at least one repeater can be connected to the AP, at least one display 300 can be provided.

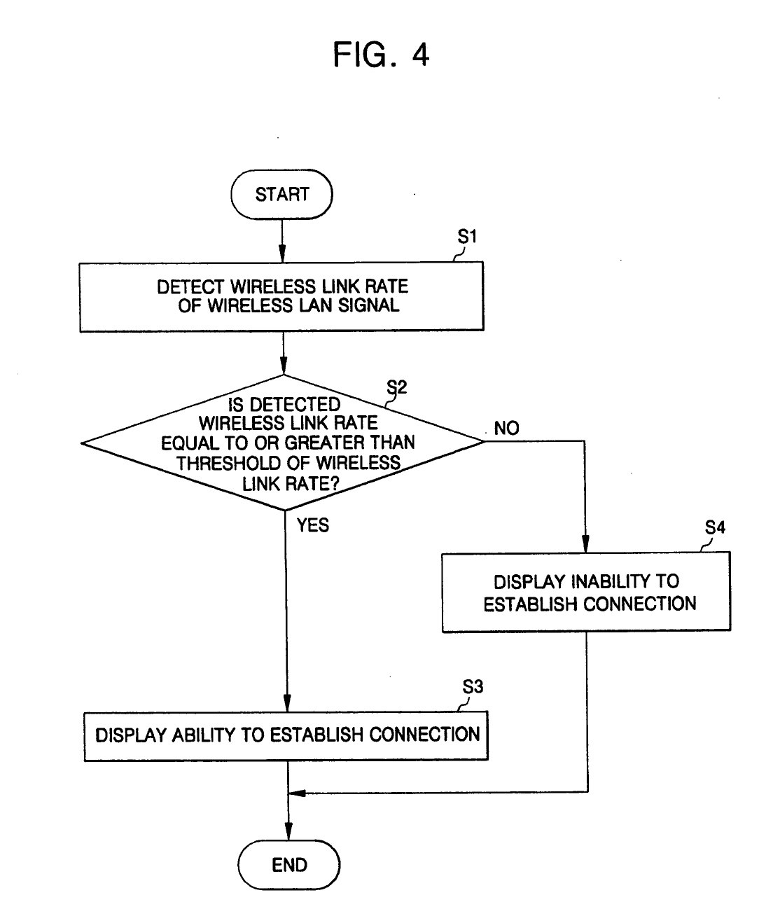

A method of controlling a WDS wireless link status in the WLAN system according to the present invention is explained below with reference to FIG. 4.

First, the wireless link rate of the received WLAN signal is detected (step SI).

Then, the detected wireless link rate is compared to the previously set wireless link rate (step S2).

Next, when it has been determined in step S2 that the detected wireless link rate is equal to or greater than the threshold of the previously set wireless link rate, an ability to establish a connection is indicated to the user (step S3).

On the other hand, when it has been determined in step S2 that the detected wireless link rate is smaller than the threshold of the previously set wireless link rate, an inability to establish a connection is indicated to the user (step S4).

Finally, the wireless link rate threshold registered in the wireless link rate table is changed or set according to the data transmission rate of the WLAN signal.

As described above, according to the WLAN and its control method, since installation information such as the setting distance and the transmission rate is indicated to the user, it is easy to install the WLAN.

While the present invention has been described with reference to exemplary embodiments thereof, it will be understood by those skilled in the art that various modifications in form and detail can be made therein without departing from the scope of the present invention as defined by the following claims.

What is claimed is:

1. A Wireless Distribution System (WDS) repeater in a Wireless Local Area Network (WLAN), the WDS repeater comprising:
a controller adapted to compare a wireless link rate of a WLAN signal received from an Access Point (AP) of the WLAN to a wireless link rate threshold registered in a wireless link rate table, and to display a connectability status of the wireless link according to the comparison result.

2. The repeater of claim 1, wherein the controller comprises:
a detector adapted to detect the wireless link rate of the WLAN signal received from the AP;
a comparator adapted to compare the wireless link rate detected by the detector to the wireless link rate threshold registered in the wireless link table; and
a display adapted to display the connectability status according to the comparison result.

3. The repeater of claim 2, wherein the controller further comprises:
a setter adapted to change or set the wireless link rate threshold registered in the wireless link table according a data transmission rate of the WLAN signal.

4. The repeater of claim 1, wherein the controller is adapted to detect the wireless link rate using one of a Communication Quality (CQ) level, a Received Signal Strength Indicator (RSSI) level, or a ping delay.

5. The repeater of claim 2, wherein the wireless link rate table comprises transmission rates of the WLAN signal and at least one wireless link rate threshold depending on the transmission rate of the WLAN signal according to a draft WLAN standard.

6. The repeater of claim 2, wherein the display comprises at least one LED or alarm adapted to indicate the connectability status of a wireless link to another AP.

7. A method of displaying a Wireless Distribution System (WDS) link status in a Wireless Local Area Network (WLAN), the method comprising:
detecting a wireless link rate of a WLAN signal received from an Access Point (AP);
comparing the detected wireless link rate to a wireless link rate threshold registered in a wireless link rate table; and
displaying an ability to establish a connection when the detected wireless link rate is equal to or greater than the wireless link rate threshold.

8. The method of claim 7, further comprising displaying an inability to establish a connection when the detected wireless link rate is smaller than the threshold of the previously set wireless link rate.

9. The method of claim 8, further comprising changing or setting the wireless link rate threshold registered in the wireless link rate table according to a data transmission rate of the WLAN signal.

10. The method of claim 8, wherein the wireless link rate is detected using one of a Communication Quality (CQ) level, a Received Signal Strength Indicator (RSSI) level, or a ping delay.

11. The method of claim 8, wherein, in comparing the detected wireless link rate to a wireless link rate threshold registered in a wireless link rate table, the wireless link rate table comprises transmission rates of the WLAN signal and at least one wireless link rate threshold depending on a transmission rate of the WLAN signal according to a draft WLAN standard.

12. A Wireless Local Area Network (WLAN) comprising:
a repeater adapted to compare a wireless link rate of a WLAN signal received from an Access Point (AP) to a wireless link rate threshold registered in a wireless link rate table and to display a connectability status of the wireless link according to the comparison result.

13. The WLAN of claim 12, wherein the repeater comprises:
a detector adapted to detect the wireless link rate of the WLAN signal received from the AP;
a comparator adapted to compare the wireless link rate detected by the detector to the wireless link rate threshold registered in the wireless link table; and
a display adapted to display the connectability status according to the comparison result.

14. The WLAN of claim 13, wherein the repeater further comprises:
a setter adapted to change or set the wireless link rate threshold registered in the wireless link table according a data transmission rate of the WLAN signal.

15. The WLAN of claim 12, wherein the repeater is adapted to detect the wireless link rate using one of a Communication Quality (CQ) level, a Received Signal Strength Indicator (RSSI) level, or a ping delay.

16. The WLAN of claim 13, wherein the wireless link rate table comprises transmission rates of the WLAN signal and at least one wireless link rate threshold depending on the transmission rate of the WLAN signal according to a draft WLAN standard.

17. A Wireless Local Area Network (WLAN) comprising:
an Access Point (AP) adapted to receive a WLAN signal from a repeater; to compare a wireless link rate of the received WLAN signal from a repeater to a wireless link rate threshold registered in a wireless link rate table; and to display a connectability status of the wireless link according to the comparison result.

18. The WLAN of claim 17, wherein the AP comprises:
a detector adapted to detect the wireless link rate of the received WLAN signal from the repeater;
a comparator adapted to compare the wireless link rate detected by the detector to the wireless link rate threshold registered in the wireless link table; and
a display adapted to display the connectability status according to the comparison result.

19. The WLAN of claim 18, wherein the AP further comprises:
a setter adapted to change or set the wireless link rate threshold registered in the wireless link table according a data transmission rate of the WLAN signal.

20. The WLAN of claim 17, wherein the AP is adapted to detect the wireless link rate using one of a Communication Quality (CQ) level, a Received Signal Strength Indicator (RSSI) level, or a ping delay.
